(19) United States
(12) Patent Application Publication
(10) Pub. No.: US 2026/0135959 A1
(43) Pub. Date: May 14, 2026

(54) IMAGE FORMING APPARATUS AND IMAGE PROCESSING METHOD

(71) Applicant: CANON KABUSHIKI KAISHA, Tokyo (JP)

(72) Inventor: TORU WAKANA, Chiba (JP)

(21) Appl. No.: 19/373,509

(22) Filed: Oct. 29, 2025

(30) Foreign Application Priority Data
Nov. 11, 2024 (JP) 2024-196968

(51) Int. Cl. H04N 1/00; H04N 1/387

(52) U.S. Cl. CPC H04N 1/00639; H04N 1/3877; H04N 2201/0094

(57) ABSTRACT

An image forming apparatus includes a reception unit that receives a bookbinding setting for setting an opening direction of a booklet discharged after sheets are bound by a post-processing apparatus, an acquisition unit that acquires image data, an image processing unit that performs image processing, based on the received bookbinding setting, for rotating an image based on the image data, and a printing unit that prints the image subjected to the image processing on a sheet, wherein the printed sheets are conveyed to the post-processing apparatus, bound into a booklet, and the booklet discharged based on the received bookbinding setting.

### BACKGROUND

### Field of the Technology

The present disclosure relates to an image forming apparatus and an image processing method.

### Description of the Related Art

In a known saddle stitch bookbinding technique, images based on bookbinding-imposed print data are double-sided printed by an image forming apparatus, and the print product is conveyed to a bookbinding apparatus and subjected to saddle stitch bookbinding by the bookbinding apparatus.

Japanese Patent Laid-Open No. 2010-184452 describes a technique in which a printing apparatus performs printing on sheets by changing the order of print pages so that the printed sheets can be set to a bookbinding apparatus, thus enabling the bookbinding apparatus to bind the print product to produce a booklet.

A user can set any one of the rightward, leftward, upward, or downward opening directions of a discharged booklet. However, when using a bookbinding apparatus that does not change the orientation of the discharged booklet, the booklet may be inconveniently discharged with the surface unintended by the user upwardly oriented depending on the set opening direction.

### SUMMARY

According to an aspect of the present disclosure, an image forming apparatus includes a reception unit configured to receive a bookbinding setting for setting an opening direction of a booklet discharged after sheets are bound by a post-processing apparatus, an acquisition unit configured to acquire image data, an image processing unit configured to perform image processing, based on the received bookbinding setting, for rotating an image based on the image data, and a printing unit configured to print the image subjected to the image processing on a sheet, wherein printed sheets are conveyed to the post-processing apparatus, bound into a booklet, and the booklet discharged based on the received bookbinding setting.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a configuration of an image forming apparatus.

FIG. 2 illustrates a configuration of a control unit of the image forming apparatus.

FIG. 3 illustrates a printer driver setting screen.

FIG. 4 illustrates examples of document data.

FIG. 5 illustrates examples of bookbinding-imposed data.

FIG. 6 illustrates examples of an opening direction of bookbinding.

FIG. 7 illustrates discharge states for a discharge tray of bookbinding.

FIG. 8 illustrates a structure of print data.

FIG. 9 illustrates patterns of bookbinding-imposed image data.

FIG. 10 illustrates types of a bookbinding apparatus.

FIG. 11 illustrates determination of image data rotation.

FIG. 12 illustrates a flowchart of the present disclosure.

FIG. 13 illustrates another flowchart of the present disclosure.

### DESCRIPTION OF THE EMBODIMENTS

Embodiments of the present disclosure will be described in detail below with reference to the accompanying drawings.

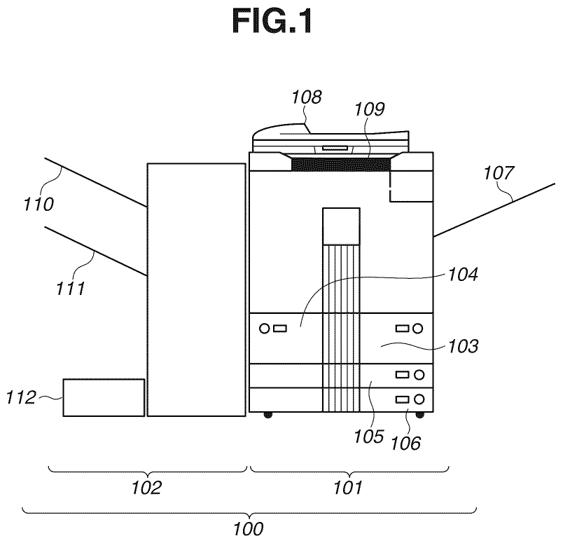

FIG. 1 is a block diagram illustrating an example of a print bookbinding apparatus according to the present disclosure.

A print bookbinding apparatus 100 includes a printing apparatus 101 and a bookbinding apparatus 102.

The printing apparatus 101 performs image formation and printing. The printing apparatus 101 is an example of an image forming apparatus, and may be a multi-function peripheral (MFP), a printer, or the like. The printing apparatus 101 having an image processing function also serves as an image processing apparatus. The printing apparatus 101 includes a control unit 200 that operates software for controlling the print bookbinding apparatus 100.

The bookbinding apparatus 102 binds paper (sheets) printed by the printing apparatus 101. The bookbinding apparatus 102 is an example of a post-processing apparatus. Bookbinding means post-processing. The bookbinding apparatus 102 supplied with sheets printed by the printing apparatus 101 subjects the supplied sheets to saddle stitch bookbinding and discharges the bound sheets to a discharge unit. The bookbinding apparatus 102 is controlled by the above-described control unit 200.

Sheet feeding units 103 to 107 supply sheets, and. Sheets of different sizes can be set to the sheet feeding units 103 to 107. The printing apparatus 101 selects a suitable paper size and a suitable sheet cassette based on the print size, and supplies the sheets. The number and arrangements of sheet feeding units are not limited thereto. A reading apparatus 108 is an apparatus for reading a document. Examples of the reading apparatus 108 include a scanner and an automatic document feeder (ADF). An operation unit 109 is used to operate the print bookbinding apparatus 100, and includes a display for displaying information and keys for inputting information.

Discharge trays 110 and 111 are used to discharge sheets when the sheets supplied from the printing apparatus 101 to the bookbinding apparatus 102 are not subjected to saddle stitch bookbinding. The discharge tray 112 is used to discharge sheets when the sheets supplied from the printing apparatus 101 to the bookbinding apparatus 102 are subjected to saddle stitch bookbinding.

According to the present disclosure, the printing apparatus 101 and the bookbinding apparatus 102 are connected, and the sheets printed by the printing apparatus 101 are conveyed and supplied to the bookbinding apparatus 102 for bookbinding (post-processing). However, the printing apparatus 101 and the bookbinding apparatus 102 do not need to be connected. The user may bring a print product printed by the printing apparatus 101 to the bookbinding apparatus 102, and place the print product on a sheet feeding unit of the bookbinding apparatus 102. In this case, the printing apparatus 101 and the bookbinding apparatus 102 implement respective functions through different control units.

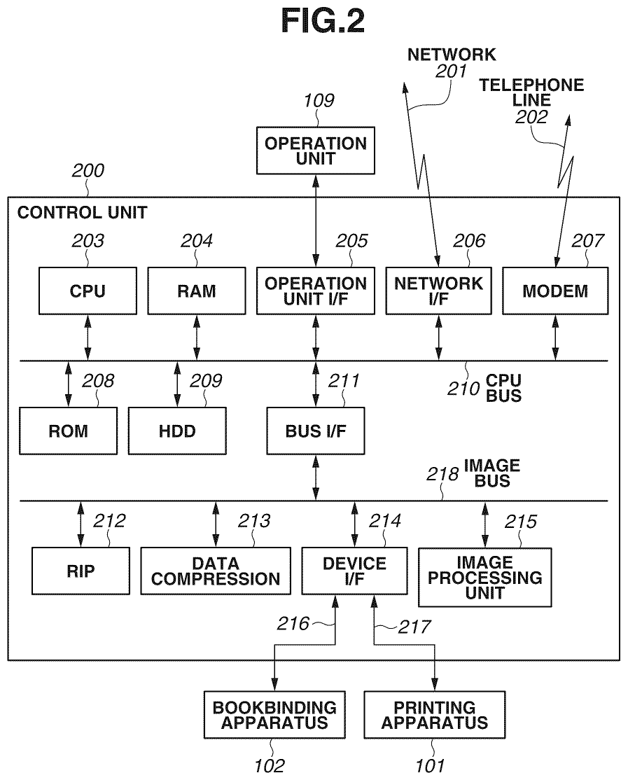

FIG. 2 is a block diagram illustrating a configuration of the control unit 200 of the print bookbinding apparatus 100 of the present disclosure.

A network 201 connects the print bookbinding apparatus 100 with an external apparatus. A telephone line 202 connects the print bookbinding apparatus 100 with an external apparatus. A central processing unit (CPU) 203 operates a program for controlling each component of the control unit 200. The CPU 203 transmits printing and bookbinding instructions to the printing apparatus 101 and the bookbinding apparatus 102, based on signals input from the operation unit 109 or from the external apparatus via the network 201, via data buses 217 and 216 respectively.

A random access memory (RAM) 204 is controlled by a program executed by the CPU 203 and used as the main memory of the CPU 203 and a primary storage area such as a work area. The RAM 204 has a function of a receive buffer for temporarily storing data received external from the print bookbinding apparatus 100 and a function of an image data buffer for temporarily storing image data rasterized by a Raster Image Processor (RIP).

An operation unit interface (I/F) 205 connects the operation unit 109 and the control unit 200. A network I/F 206 is an interface for connecting the control unit 200 to the network 201. A modulator/demodulator (MODEM) 207 is an interface for connecting the control unit 200 to the telephone line 202. A read only memory (ROM) 208 stores a program and data operating on the CPU 203. A hard disk drive (HDD) 209 is a nonvolatile storage device that can store various data for a prolonged time period.

A CPU bus 210 is a data transmission line. A bus interface (I/F) 211 connects the CPU bus 210 and an image bus 218. Thus, the above-described components of the control unit 200 connected to the CPU bus 210 or the image bus 218 are communicably connected with each other. A raster image processer (RIP) 212 has a function of converting page description language (PDL) data input from external to the print bookbinding apparatus 100 into bitmap image data. A compression unit 213 has a function of compressing data.

A device I/F 214 is an interface for connecting the bookbinding apparatus 102 and the printing apparatus 101 to the image bus 218 via the data buses 216 and 217, respectively. The image processing unit 215 subjects the bitmap image data generated by the RIP 212 to various image processing. The CPU 203 performs printing while issuing printing instructions to the printing apparatus 101 and the bookbinding apparatus 102, based on instruction signals received from the operation unit 109 or from the external apparatus via the network 201, via the data buses 217 and 216 respectively.

The data buses 216 and 217 and the image bus 218 are connected to the above-described components of the control unit 200 for performing image processing.

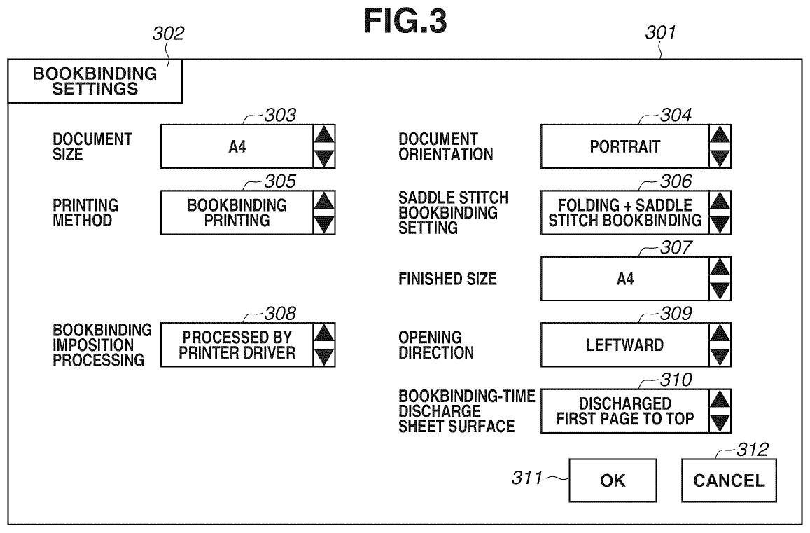

FIG. 3 illustrates an example of a printer driver setting screen 301 that is a screen for setting a printer driver. The printer driving screen 301 is displayed on the display unit of the operation unit 109 or the external apparatus connected via the network 201.

A bookbinding setting tab 302 indicates that a “Bookbinding Setting” setting screen is displayed. A region 303 enables the user to set the document size of the paper to be supplied to the printing apparatus 101, such as “A4” and “A3”. The region 303 in FIG. 3 indicates an example where “A4” is set as the document size.

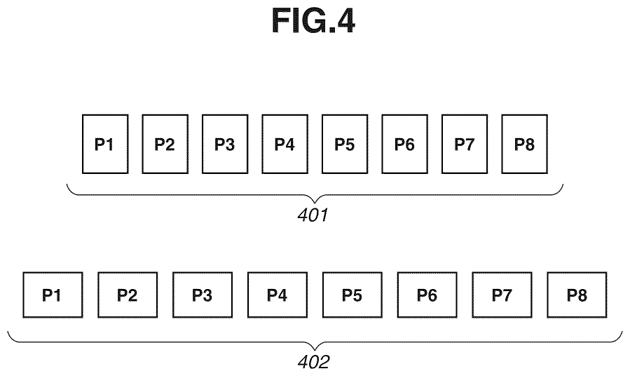

A region 304 enables the user to set the document orientation: “Portrait” or “Landscape”. FIG. 4 illustrates examples of the document orientation. An image data set 401 is an example of vertical image data including eight pages. In this case, the document orientation in the region 304 is “Portrait”. An image data set 402 is an example of horizontal image data including eight pages. In this case, the document orientation in the region 304 is “Landscape”. The region 304 in FIG. 3 indicates an example where “Portrait” is set as the document orientation.

A region 305 enables the user to set the printing method such as “Bookbinding Printing” and “Double-sided Printing”. A region 306 enables the user to set the saddle stitch bookbinding: “Folding +Saddle Stitch Bookbinding” or “Only Folding”. The region 306 in FIG. 3 indicates an example where “Folding +Saddle Stitch Bookbinding” is set.

A region 307 enables the user to set the finished size. The sheet size refers to the size of a print product such as a bound booklet (the size of each page of the booklet after saddle stitch bookbinding). The size of the booklet to be output after bookbinding can be set. The region 307 in FIG. 3 indicates an example where “A4” is set. In this case, if the printing apparatus 101 performs printing with the “A3” size that is twice the “A4” size, and the bookbinding apparatus 102 applies “Folding +Saddle Stitch Bookbinding” to the “A3” size paper, an “A4” size print product is produced.

A region 308 enables the user to set the bookbinding imposition processing. The bookbinding imposition processing can be performed via a printer driver or the operation unit 109. The region 308 in FIG. 3 indicates an example where “Processing by Printer Driver” is set.

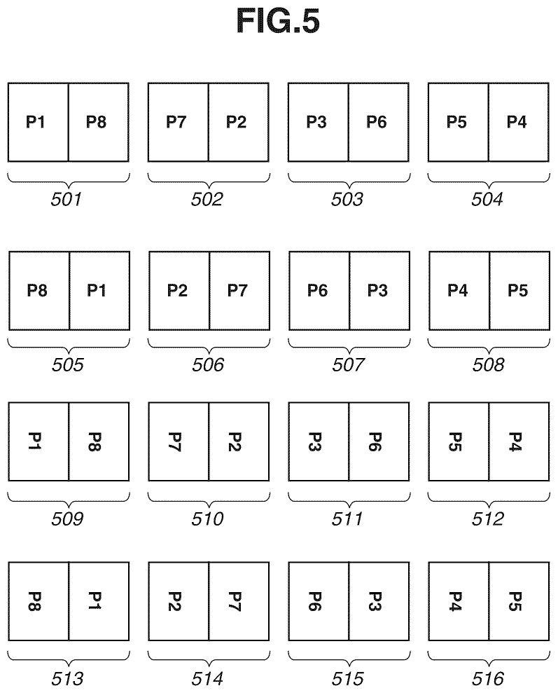

The bookbinding imposition processing will be described below. The bookbinding imposition processing refers to converting document data into a layout for bookbinding. For example, when the image data set 401 is subjected to the bookbinding imposing processing, image data sets 501 to 508 in FIG. 5 are generated as layouts for bookbinding. When the image data set 402 has been subjected to bookbinding imposition processing, image data sets 509 to 516 in FIG. 5 are generated as layouts for bookbinding.

A region 309 enables the user to set the opening direction of bookbinding: “Leftward”, “Upward”, “Downward”, or “Rightward”. More specifically, when the user sets the region 309, the user can set the opening direction of the discharged booklet after sheets are bound by the post-processing apparatus. When the region 309 is set, the CPU 203 receives the setting of the opening direction of the discharged booklet.

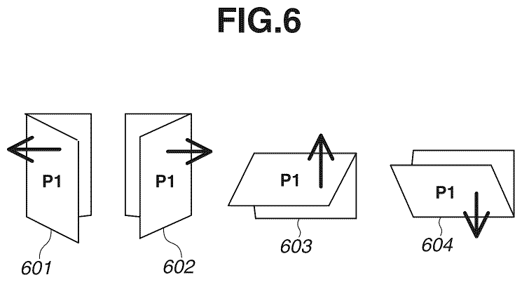

FIG. 6 is a schematic view illustrating the opening direction of a booklet. An opening example 601 is an example of a leftward booklet. The opening example 601 has a page order that a surface denoted by P2 appears when a surface denoted by P1 is turned over in the direction of the arrow (leftward). An opening example 602 is an example of a rightward booklet. The opening example 602 has a page order that the surface denoted by P2 appears when the surface denoted by P1 is turned over in the direction of the arrow (rightward). An opening example 603 is an example of an upward booklet. The opening example 603 has a page order that the surface denoted by P2 appears when the surface denoted by P1 is turned over in the direction of the arrow (upward). An opening example 604 is an example of a downward booklet. The opening example 604 has a page order that the surface denoted by P2 appears when the surface denoted by P1 is turned over in the direction of the arrow (downward). The region 309 in FIG. 3 indicates an example where “Leftward” is set.

Returning to FIG. 3, a region 310 enables the user to set a bookbinding-time discharge sheet surface. The bookbinding-time discharge sheet surface refers to the page to be discharged to the top when a print product (a booklet with saddle stitch bookbinding) is discharged onto the discharge tray 112 of the bookbinding apparatus 102. The region 310 enables the user select “First Page Discharged to Top” or “First Page Discharged to Bottom”. The region 310 in FIG. 3 indicates an example where “First Page Discharged to Top”. The user can perform printing and bookbinding without making the discharge sheet surface setting for the region 310. In this case, the image data is not subjected to the rotation processing, and the cover (first page) of the bound booklet is upwardly or downwardly discharged.

Pressing an OK key 311 enables the above-described setting values. Printing is performed when a printing execution button is pressed. Pressing a Cancel key 312 cancels the above-described setting values. When the Cancel key 312 is pressed, the printer driver setting screen 301 is completed and closed.

As described above, FIG. 4 illustrates examples of document orientation. More specifically, FIG. 4 illustrates examples of image data acquired by the print bookbinding apparatus 100, i.e., vertically long (portrait) or horizontally long (landscape) image data sets. Image data sets 401 and 402 are generated, for example, when the image data is sent from an external apparatus connected with the print bookbinding apparatus 100 via the network 201 or when a document is read by the reading apparatus 108. As discussed above, the image data set 401 is an example of image data for a portrait document including eight pages, while the image data set 402 is an example of image data for a landscape document including eight pages.

As previously described, FIG. 5 illustrates print data generated by subjecting image data to bookbinding imposition processing. Print data is also a type of image data. FIG. 5 illustrates an example of image bookbinding-imposed image data (hereinafter referred to as bookbinding-imposed image data) generated based on the premise that the print data is to be printed double-sided.

The print data 501 to 504 indicate examples of bookbinding imposition performed to bind a rightward booklet.

The print data 501 represents a page on which P1 and P8 of the image data set 401 are disposed. The print data 502 represents a page on which P2 and P7 of the image data set 401 are disposed. The print data 503 represents a page on which P3 and P6 of the image data set 401 are disposed. The print data 504 represents a page on which P4 and P5 of the image data set 401 are disposed.

The print data 501 is printed on a first surface (front surface) of a sheet. The print data 502 is printed on a second surface (back surface) of the sheet with the print data 501 printed thereon, where the print data 501 is not printed. The print data 503 is printed on a first surface (front surface) of a sheet different from the sheet with the print data 501 and 502 printed thereon. The print data 504 is printed on a second surface (back surface) of the sheet with the print data 503 printed thereon, where the print data 503 is not printed. A booklet is finished when sheets subjected to this way of double-sided printing are bound as described below.

The print data 505 to 508 indicate examples of bookbinding imposition performed to bind a leftward booklet.

The print data 505 represents a page on which P8 and P1 of the image data set 401 are disposed. The print data 506 represents a page on which P7 and P2 of the image data set 401 are disposed. The print data 507 represents a page on which P6 and P3 of the image data set 401 are disposed. The print data 508 represents a page on which P5 and P4 of the image data set 401 are disposed.

The print data 505 is printed on a first surface (front surface) of a sheet. The print data 506 is printed on a second surface (back surface) of the sheet with the print data 505 printed thereon, where the print data 505 is not printed. The print data 507 is printed on a first surface (front surface) of a sheet different from the sheet with the print data 505 and 506 printed thereon. The print data 508 is printed on a second surface (back surface) of the sheet with the print data 507 printed thereon, where the print data 507 is not printed. A booklet is finished when sheets subjected to this way of double-sided printing are bound as described below.

The print data 509 to 512 indicate examples of bookbinding imposition performed to bind an upward booklet.

The print data 509 represents a page on which P1 and P8 of the image data set 402 are disposed. The print data 510 represents a page on which P2 and P7 of the image data set 402 are disposed. The print data 511 represents a page on which P3 and P6 of the image data set 402 are disposed. The print data 512 represents a page on which P4 and P5 of the image data set 402 are disposed.

The print data 509 is printed on a first surface (front surface) of a sheet. The print data 510 is printed on a second surface (back surface) of the sheet with the print data 509 printed thereon, where the print data 509 is not printed. The print data 511 is printed on a first surface (front surface) of a sheet different from the sheet with the print data 509 and 510 printed thereon. The print data 512 is printed on a second surface (back surface) of the sheet with the print data 511 printed thereon, where the print data 511 is not printed. A booklet is finished when sheets subjected to this way of double-sided printing are bound as described below.

The print data 513 to 516 indicate examples of bookbinding imposition performed to bind a downward booklet.

The print data 513 represents a page on which P8 and P1 of the image data set 402 are disposed. The print data 514 represents a page on which P7 and P2 of the image data set 402 are disposed. The print data 515 represents a page on which P6 and P3 of the image data set 402 are disposed. The print data 516 represents a page on which P5 and P4 of the image data set 402 are disposed.

The print data 513 is printed on a first surface (front surface) of a sheet. The print data 514 is printed on a second surface (back surface) of the sheet with the print data 513 printed thereon, where the print data 513 is not printed. The print data 515 is printed on a first surface (front surface) of a sheet different from the sheet with the print data 513 and 514 printed thereon. The print data 516 is printed on a second surface (back surface) of the sheet with the print data 515 printed thereon, where the print data 515 is not printed. A booklet is finished when sheets subjected to this way of double-sided printing are bound as described below.

According to the present disclosure, P denotes a page. Referring to the print data 501 and the like, the page P1 may become the front cover, and the page P8 may become the back cover. The present disclosure does not distinguish between a booklet that defines the front cover as the first page and a booklet that defines the page seen after turning over the front cover as the first page.

According to the present disclosure, the print data 501 to 516 are print data subjected to the bookbinding imposition processing. An image represented by the data to be printed on one surface of a sheet and the image printed on the sheet are defined as a surface. When printed sheets form a booklet, the outer surface of the outermost sheet is referred to as a first surface, the inner surface of the outermost sheet is referred to as a second surface, the outer surface of the second outermost sheet is referred to as a third surface, and the inner surface of the second outermost sheet is referred to as a fourth surface.

Based on this definition, the N-th surface (image to be rotated) includes the image of the N-th page of the acquired image data and the image of the (n+1−N)-th page of the acquired image data, where “n” denotes the total number of pages of the acquired image data. For example, since the image data set 401 includes a total of eight pages, the second surface (print data 502) includes the image of the second page of the image data set 401 and the image of the seventh page of the image data set 401.

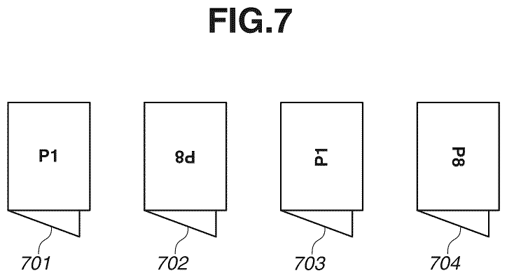

FIG. 7 illustrates discharge states where a bound booklet is discharged onto the discharge tray 112 of the bookbinding apparatus 102.

In a state 701, the surface of P1 comes to the top when a leftward booklet processed with saddle stitch bookbinding by the bookbinding apparatus 102 is discharged onto the discharge tray 112. In a state 702, the surface of P8 comes to the top when a leftward booklet processed with saddle stitch bookbinding by the bookbinding apparatus 102 is discharged onto the discharge tray 112. The state 702 is the reversed state of the state 701.

In a state 703, the surface denoted by P1 comes to the top when an upward booklet processed with saddle stitch bookbinding by the bookbinding apparatus 102 is discharged onto the discharge tray 112. In a state 704, the surface denoted by P8 comes to the top when an upward booklet processed with saddle stitch bookbinding by the bookbinding apparatus 102 is discharged onto the discharge tray 112. The state 704 is the reversed state of the state 703.

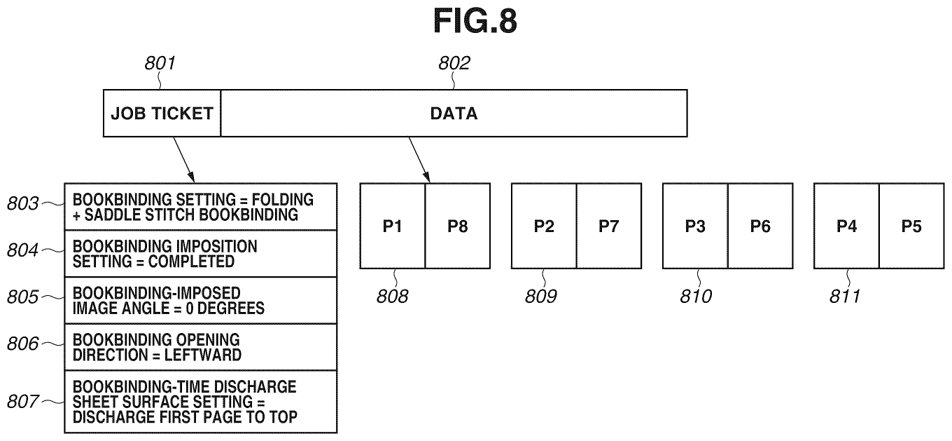

FIG. 8 illustrates an example of a print job setting for a print job as Page Description Language (PDL) data input from a host computer and the like via the network 201. Examples of other print jobs include a copy job generated when a document is read by the reading apparatus 108 mounted on the printing apparatus 101 or a spooled print job temporarily spooled in a storage device such as the HDD 209.

A job ticket portion 801 includes, for example, information indicating bookbinding settings such as a bookbinding specification and print settings such as a color/monochrome setting. According to the present disclosure, a job ticket is a job control language.

According to the present disclosure, a data portion 802 includes Page Description Language (PDL) data, and image data included in the data portion 802 is equivalent to print data. As described above, print data may be acquired when a document is read by the reading apparatus 108 of the printing apparatus 101 or acquired from a spooled print job temporarily spooled in a storage device such as the HDD 209.

Bookbinding specification information 803 indicates the bookbinding setting information included in the job ticket portion 801. The example in FIG. 8 includes information that “Folding +Saddle Stitch Bookbinding” is set as the bookbinding specification. According to the present disclosure, “Only Folding” or “Folding +Saddle Stitch Bookbinding” can be set. This setting is equivalent to the “Saddle Stitch Bookbinding Setting” setting value in the printer driver setting screen 301.

Bookbinding imposition setting information 804 indicates the bookbinding imposition setting information included in the job ticket portion 801, and includes information about whether the image data in the data portion 802 is bookbinding-imposed data. According to the present disclosure, either “Completed” or “Not Completed” is set. If the bookbinding imposition processing setting value in the printer driver setting screen 301 is “Processing by Printer Driver”, the setting of the information 804 is “Completed”. If the setting value is “Processing by Image Forming Apparatus”, the setting of the information 804 is “Not Completed”.

Angle information 805 indicates the bookbinding-imposed image angle information included in the job ticket portion 801. If the image data in the data portion 802 is bookbinding-imposed data, the angle information 805 includes information indicating the bookbinding-imposed image angle setting. According to the present disclosure, “0 Degrees”, “90 Degrees”, “180 Degrees”, or “270 Degrees” is set.

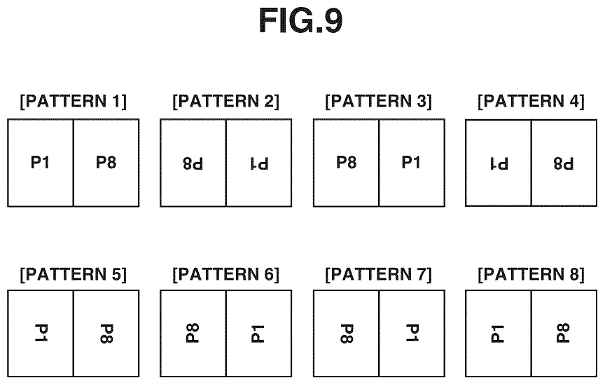

An example of the rotational angle of the bookbinding-imposed image will be described below with reference to FIG. 9. The setting “0 Degrees” indicates states of patterns 1 and 3 in FIG. 9 where the top of the image is upwardly positioned. The setting “90 Degrees” indicates states of patterns 5 and 7 in FIG. 9 where the top of the image is rightwardly positioned. The setting “180 Degrees” indicates states of patterns 2 and 4 in FIG. 9 where the top of the image is downwardly positioned. The setting “270 Degrees” indicates states of patterns 6 and 8 in FIG. 9 where the top of the image is leftwardly positioned. While the angle in the clockwise direction is defined as a positive angle as described above, the angle in the counterclockwise direction may be defined as a positive angle.

Returning to FIG. 8, bookbinding opening setting information 806 indicates the bookbinding opening direction information included in the job ticket portion 801, and includes bookbinding opening direction setting information. According to the present disclosure “Leftward”, “Rightward”, “Upward”, or “Downward” is set. This setting is equivalent to the “Opening Direction” setting value in the printer driver setting screen 301.

Bookbinding-time discharge sheet surface setting information 807 indicates the discharge sheet surface setting at the time of bookbinding included in the job ticket portion 801, and includes bookbinding-time discharge sheet surface setting information such as “First Page Discharged to Top”. According to the present disclosure, “First Page Discharged to Top” or “First Page Discharged to Bottom” is set.

The user can leave these settings unselected. This setting is equivalent to the “Bookbinding-time Discharge Sheet Surface” setting value (region 310) in the printer driver setting screen 301.

Print data 808 to 811 indicate different pages of the bookbinding-imposed image data included in the data portion 802. The print data 808 indicates the first page of the bookbinding-imposed image data, and indicates that the surfaces “P1” and “P8” are imposed. The print data 809 indicates the second page of the bookbinding-imposed image data, and indicates that the surfaces “P2” and “P7” are imposed. The print data 810 indicates the third page of the bookbinding-imposed image data, and indicates that the surfaces “P3” and “P6” are imposed. The print data 811 indicates the fourth page of the bookbinding-imposed image data, and indicates that the surfaces “P4” and “P5” are imposed. According to the present disclosure, the print data with bookbinding-imposed image data is included in a print job as illustrated in FIG. 8. Image data before being subjected to bookbinding imposition may be included in a print job.

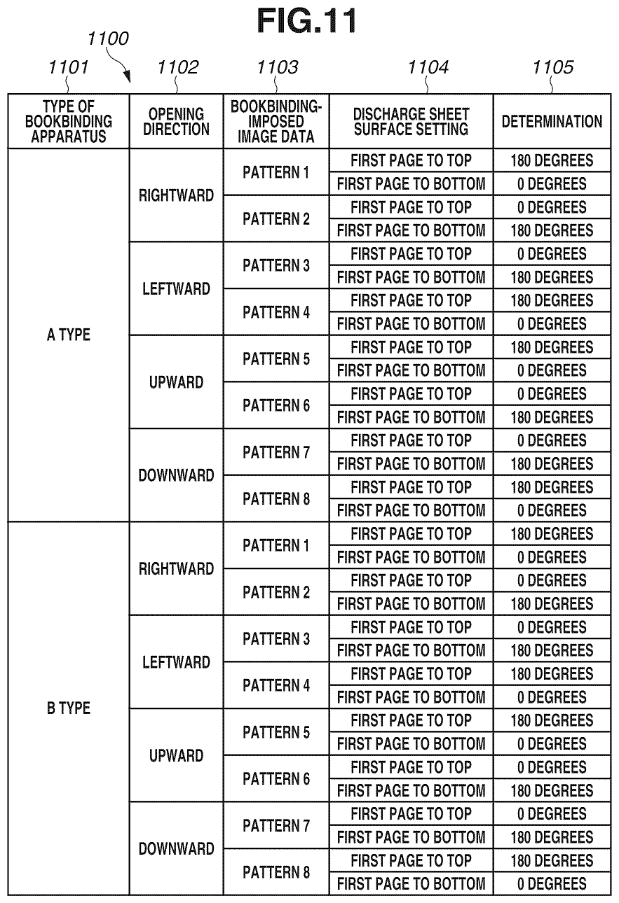

FIG. 9 illustrates the first page of the bookbinding-imposed image data. This means that a parameter 1103, described below with respect to FIG. 11, indicates information about the rotational angle of the image denoted by the acquired image data.

Pattern 1 is bookbinding-imposed image data to be used for a rightward booklet, and indicates that the rotational angle of the bookbinding-imposed image is 0 degrees. Pattern 2 is bookbinding-imposed image data to be used for a rightward booklet, and indicates that the rotational angle of the bookbinding-imposed image is 180 degrees. Pattern 3 is bookbinding-imposed image data to be used for a leftward booklet, and indicates that the rotational angle of the bookbinding-imposed image is 0 degrees. Pattern 4 is bookbinding-imposed image data to be used for a leftward booklet, and indicates that the rotational angle of the bookbinding-imposed image is 180 degrees.

Pattern 5 is bookbinding-imposed image data to be used for an upward booklet, and indicates that the rotational angle of the bookbinding-imposed image is 90 degrees. Pattern 6 is bookbinding-imposed image data to be used for an upward booklet, and indicates that the rotational angle of the bookbinding-imposed image is 270 degrees.

Pattern 7 is bookbinding-imposed image data to be used for a downward booklet, and indicates that the rotational angle of the bookbinding-imposed image is 90 degrees. Pattern 8 is bookbinding-imposed image data to be used for a downward booklet, and indicates that the rotational angle of the bookbinding-imposed image is 270 degrees.

While, according to the present disclosure, the angle in the clockwise direction is defined as a positive angle as described above, the angle in the counterclockwise direction may be defined as a positive angle.

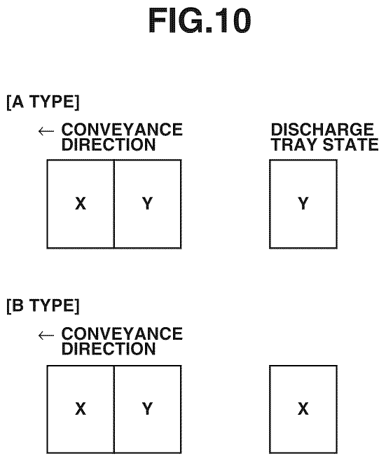

FIG. 10 illustrates a relation between the direction in which a sheet is conveyed from the printing apparatus 101 to the bookbinding apparatus 102 and the discharge sheet surface (top surface) when the sheet is discharged onto the discharge tray 112 of the bookbinding apparatus 102. The bookbinding apparatus 102 according to the present disclosure may be an A type configuration or a B type configuration.

Generally, apparatuses having the A or the B type configurations are separate apparatuses and cannot be connected to the printing apparatus 101 at the same time. An example where the bookbinding apparatus 102 of either type is connected to the printing apparatus 101 according to the present disclosure will be described below.

With the A type, assume a case where a sheet is conveyed to the bookbinding apparatus 102 with the printing surface upwardly oriented, a page X on the leading edge side, and a page Y on the trailing edge side in the sheet conveyance direction. In this case, a booklet having been subjected to stitch bookbinding processing by the bookbinding apparatus 102 is discharged so that the page Y comes to the top.

With the B type, assume a case where a sheet is conveyed to the bookbinding apparatus 102 with the printing surface downwardly oriented, a page X on the leading edge side, and a page Y on the trailing edge side in the sheet conveyance direction. In this case, a booklet having been subjected to stitch bookbinding processing by the bookbinding apparatus 102 is discharged so that the page X comes to the top.

Information about whether the bookbinding apparatus 102 connected to the printing apparatus 101 is the A or the B type is prestored in the HDD 209. The type information (capability information) of the bookbinding apparatus 102 does not have to be prestored. For example, the printing apparatus 101 may be configured to acquire the capability information for the bookbinding apparatus 102 connected to the printing apparatus 101 each time the printing apparatus 101 receives a print job. In addition, the printing apparatus 101 may be configured to acquire the capability information of the bookbinding apparatus 102 when the printing apparatus 101 and the bookbinding apparatus 102 are connected. Alternatively, the user may pre-register the capability information for the bookbinding apparatus 102 to the printing apparatus 101.

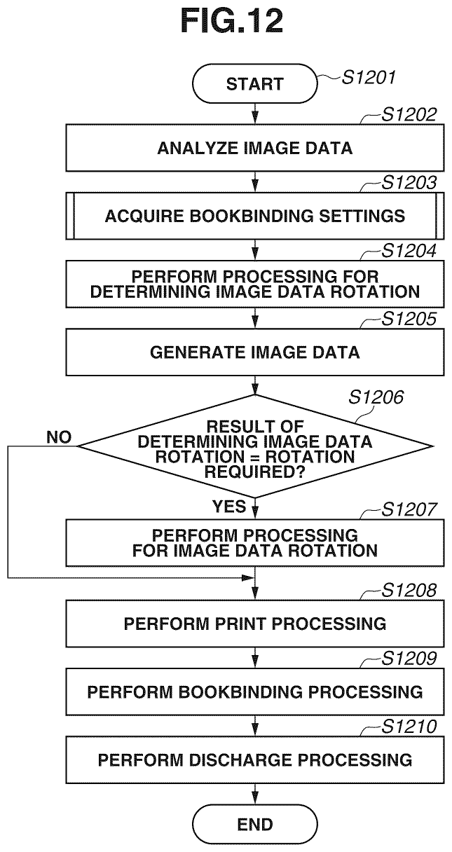

FIG. 11 illustrates a reference table 1100 for the processing for image data rotation. This table is stored in the HDD 209 and used by an image data rotation determination unit (step S1203 in FIG. 12 described below).

A parameter 1101 indicates the capability information (type) of the bookbinding apparatus 102 at the time of bookbinding described with reference to FIG. 10, i.e., the A or the B type according to the present disclosure. The present disclosure is not limited thereto. The bookbinding apparatus 102 has been described above with respect to binding a long side of sheets. There are two additional types of the bookbinding apparatus 102 for binding a short side of sheets. The bookbinding apparatus 102 may be configured to bind any portion other than the four sides of sheets, resulting in an increase in the number of types.

A parameter 1102 indicates the opening direction of a booklet (“Leftward”, “Rightward”, “Upward”, or “Downward”) due to bookbinding of the image data, and is determined based on the image data.

A parameter 1103 indicates the pattern of the bookbinding-imposed image data described above with reference to FIG. 9, and is determined based on the image data. More specifically, the parameter 1103 indicates information about the rotational angle of the image denoted by the acquired image data.

A parameter 1104 indicates the discharge sheet surface setting specifying whether the first page of a discharged booklet comes to the top or bottom. The user sets “First Page to Top” or “First Page to Bottom”.

A parameter 1105 indicates the rotational angle of the image data, and is determined by the parameters 1101 to 1104. The parameter 1105 is also used to determine image processing as described below.

FIG. 12 is a flowchart illustrating an example of bookbinding processing according to the present disclosure.

In step S1201, the CPU 203 starts the processing upon acquisition of image data.

The acquisition of image data is performed, for example, via various interfaces, the reading apparatus 108, and the like. The present disclosure will be described using the example where the CPU 203 acquires image data via the network 201 and the network I/F 206.

In step S1202, the CPU 203 analyzes the print data. The CPU 203 receives a print job including image data via the network 201 and stores the image data included in the received print job in the HDD 209. Then, the CPU 203 reads the image data stored in the HDD 209 and analyzes the image data. The CPU 203 reads the bookbinding specification information 803, the bookbinding imposition setting information 804, the bookbinding-imposed image angle information 805, the bookbinding opening setting information 806, and the bookbinding-time discharge sheet surface setting information 807 from the job ticket portion 801 in the print job, and stores each piece of information in the HDD 209. The CPU 203 analyzes PDL data of the data portion 802 in the print job, converts the PDL data into intermediate data (not illustrated), and stores the intermediate data in the HDD 209. If the bookbinding imposition setting information 804 is “Not Completed”, the CPU 203 performs the bookbinding imposition processing. The CPU 203 calculates the image angle after the bookbinding imposition based on the bookbinding opening setting information 806, and stores the image angle in the HDD 209 as the bookbinding-imposed image angle information.

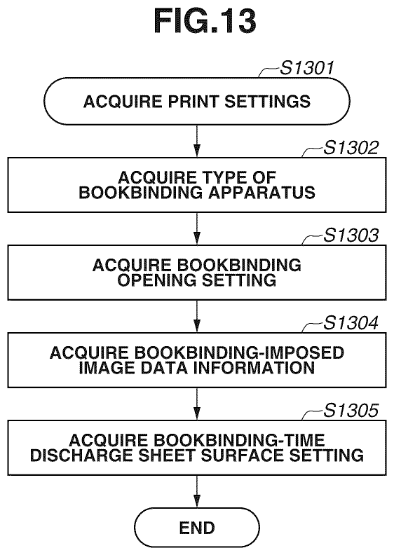

In step S1203, the CPU 203 acquires the bookbinding settings. The CPU 203 reads the bookbinding information from the HDD 209 and stores the information in the RAM 204. The acquisition of the bookbinding settings will be described below with reference to the flowchart in FIG. 13.

In step S1204, the CPU 203 performs the processing for determining the image data rotation. More specifically, the CPU 203 reads the reference table 1100 stored in the HDD 209. The CPU 203 determines whether the bookbinding-imposed image data needs to be rotated by using the reference table 1100 and the information read in step S1203.

A specific determination method will be described below with reference to FIG. 11. The CPU 203 reads the parameter 1101 indicating the type of the bookbinding apparatus 102 described above with reference to FIG. 10 from the RAM 204.

The CPU 203 determines the acquired type of the bookbinding apparatus 102 (A or B type).

The CPU 203 then reads the parameter 1102 indicating the opening direction from the RAM 204. The CPU 203 reads the parameter 1103 indicating the pattern (rotational angle) of the bookbinding-imposed image data from the RAM 204. The CPU 203 then reads the parameter 1104 indicating the bookbinding-time discharge sheet surface setting from the RAM 204.

The CPU 203 determines whether to rotate the bookbinding-imposed image data based on the above-described read information. More specifically, the CPU 203 performs the determination based on whether the parameter 1105 determined by the read information is “0 Degrees” or “180 Degrees”. If the parameter 1105 used for the determination is “0 Degrees”, the CPU 203 determines that the bookbinding-imposed image data does not need to be rotated. If the parameter 1105 is “180 Degrees”, the CPU 203 determines that the bookbinding-imposed image data needs to be rotated. The CPU 203 then stores the result of the determination in the RAM 204.

In step S1205, the CPU 203 generates image data. More specifically, the CPU 203 reads the intermediate data generated in step S1202 from the HDD 209, generates image data by using the RIP 212, and stores the data in the HDD 209. If the bookbinding imposition setting information 804 is “Not Completed”, the CPU 203 performs bookbinding imposition based on the generated image data and stores bookbinding-imposed print data in the HDD 209.

In step S1206, the CPU 203 reads the result of the processing for determining the image data rotation stored in the RAM 204 in step S1204. If the result of the determination indicates that the image data rotation is required (YES in step S1206), the processing proceeds to step S1207. If the result of the determination indicates that the image data rotation is not required (NO in step S1206), the processing proceeds to step S1208.

In step S1207, the CPU 203 performs the processing for image data rotation. More specifically, the CPU 203 reads the image data generated in step S1205 from the HDD 209. The CPU 203 then subjects the image data generated in step S1205 to the rotation processing based on the result of the processing for determining the image data rotation in step S1204. More specifically, if the parameter 1105 is “180 Degrees”, the CPU 203 performs the processing for rotating the image data by 180 degrees. The CPU 203 then stores the image data (print data) subjected to the rotation processing in the HDD 209. More specifically, the CPU 203 performs, based on the received bookbinding setting, image processing for rotating the image based on the image data.

If the CPU 203 determines that the image rotation is not required (the parameter 1105 is “0 Degrees”) in a case where the discharge sheet surface setting (region 310) for discharging the front cover of the discharged booklet to the top is received from the user, the CPU 203 does not perform the image processing for rotating the image. If the CPU 203 determines that the image rotation is required (the parameter 1105 is “180 Degrees”) in this case, the CPU 203 performs the image processing for rotating the image. This also applies to a case where the discharge sheet surface setting (region 310) for discharging the front cover of the discharged booklet to the bottom is received from the user. As described above, the CPU 203 performs the determination based on the parameter 1105 determined by the parameters 1101 to 1104.

In a case where the discharge sheet surface setting for discharging the front cover of the discharged booklet to the top or bottom is not received from the user (not set in region 310), the CPU 203 does not perform the image processing for rotating the acquired image.

In step S1208, the CPU 203 instructs the printing apparatus 101 to perform print processing. The CPU 203 reads the image data subjected to the image processing in step S1207 from the HDD 209. The CPU 203 then converts the read image data into a video signal and transmits the signal to the printing apparatus 101. The printing apparatus 101 supplies paper from any of the sheet feeding units 103 to 107, and prints the image subjected to the image processing on paper (a sheet). Printing is normally performed as double-sided printing. More specifically, the printing apparatus 101 prints the image subjected to the image processing on a sheet.

In step S1209, the CPU 203 instructs the bookbinding apparatus 102 to perform bookbinding processing. The CPU 203 instructs the bookbinding apparatus 102 to convey the sheet with the image printed thereon in step S1208. The bookbinding apparatus 102 performs the bookbinding processing to generate a booklet with saddle stitch bookbinding.

In step S1210, the CPU 203 instructs the bookbinding apparatus 102 to perform discharge processing. The CPU 203 instructs the bookbinding apparatus 102 to discharge the booklet bound in step S1209 onto the discharge tray 112. When the booklet has been discharged, the CPU 203 completes the processing. Thus, the booklet bound by the post-processing apparatus is discharged based on the opening direction set by the user. More specifically, printed sheets are conveyed to the post-processing apparatus and subjected to bookbinding, and then a booklet is discharged based on the received bookbinding setting.

FIG. 13 is a flowchart illustrating an example of processing for acquiring the bookbinding setting in step S1203.

In step S1301, the CPU 203 starts the processing.

In step S1302, the CPU 203 reads the type of the bookbinding apparatus 102 from the reference table 1100 stored in the HDD 209, and stores the reference table 1100 in the RAM 204. While the present disclosure has been described above with respect to two different types (A and B types), three or more types are also applicable.

In step S1303, the CPU 203 reads the bookbinding opening setting information 806 stored in step S1202 from the HDD 209, and stores the information 806 in the RAM 204.

In step S1304, the CPU 203 reads the bookbinding-imposed image angle information 805 stored in step S1202 from the HDD 209, and stores the information 805 in the RAM 204.

In step S1305, the CPU 203 reads the bookbinding-time discharge sheet surface setting information 807 stored in step S1202 from the HDD 209, and stores the information 807 in the RAM 204. Upon completion of step S1305, the CPU 203 completes the processing.

The printer driver setting screen 301 may be displayed on the operation unit 109 of the print bookbinding apparatus 100. The print bookbinding apparatus 100 may have a server function and communicate with an external apparatus, for example, an information processing apparatus such as a personal computer (PC). As a result of this communication, the printer driver setting screen 301 may be displayed on the screen of the external apparatus. In this case, the user can make various print settings and bookbinding settings on the printer driver setting screen 301 via an external apparatus, and the print bookbinding apparatus 100 performs the above-described processing according to these settings. This enables the user to discharge a booklet with the orientation desired by the user.

While the present disclosure has been described with respect to a case where the print settings and bookbinding settings are stored in the HDD 209, the present disclosure is not limited thereto. The setting information can be managed using a method in which the print bookbinding apparatus 100 can acquire the information via communication. For example, the setting information may be stored and managed by an external apparatus such as a PC and a cloud server connected with the print bookbinding apparatus 100. In this case, the information acquired from the HDD 209 is acquired from the external apparatus.

For example, there is a use case where, following the bookbinding processing, a discharged booklet with saddle stitch bookbinding is enclosed into an envelope. The user needs to reverse the discharged booklet depending on the orientation of the booklet. More specifically, assume a case where the user wants to enclose a booklet into an envelope with the front surface (first page) of the booklet aligned with the address side of the envelope. In this case, if the booklet is discharged onto the discharge tray 112 with the front surface of the booklet downwardly oriented, the booklet needs to be reversed before being enclosed into the envelope, which is inconvenient for the user.

The present disclosure enables the user to specify the surface to be discharged to the top of a booklet when the booklet is discharged. This makes it easier for the user to enclose the booklet into an envelope without reversing the booklet, thus improving user's convenience.

The present disclosure can also be achieved when a program for implementing at least one of the above-described functions is supplied to a system or apparatus via a network or storage medium, and at least one processor in a computer of the system or apparatus reads and executes the program. The present disclosure can also be achieved by a circuit, such as an application specific integrated circuit (ASIC), for implementing at least one of the above-described functions.

The present disclosure makes it possible to discharge a booklet in the orientation desired by a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196968, filed Nov. 11, 2024, which is hereby incorporated by reference herein in its entirety.

What is claimed is:

1. An image forming apparatus comprising:
a reception unit configured to receive a bookbinding setting for setting an opening direction of a booklet discharged after sheets are bound by a post-processing apparatus;
an acquisition unit configured to acquire image data;
an image processing unit configured to perform image processing, based on the received bookbinding setting, for rotating an image based on the image data; and
a printing unit configured to print the image subjected to the image processing on a sheet,
wherein printed sheets are conveyed to the post-processing apparatus, bound into a booklet, and the booklet discharged based on the received bookbinding setting.

2. The image forming apparatus according to claim 1, wherein the image processing unit performs image processing, based on the received bookbinding setting and capability information of the post-processing apparatus. for rotating the image based on the image data.

3. The image forming apparatus according to claim 2, wherein the bookbinding setting includes a setting whether to discharge a front cover of the booklet to a top or a bottom when the booklet is discharged from the post-processing apparatus.

4. The image forming apparatus according to claim 3,
wherein the acquisition unit further acquires information indicating a rotational angle of the image denoted by the acquired image data, and
wherein the image processing unit performs the image processing, based on the received bookbinding setting, the acquired capability information, and the information indicating the rotational angle of the image denoted by the acquired image data. for rotating the image based on the image data.

5. The image forming apparatus according to claim 3, wherein, in a case where the reception unit receives a discharge sheet surface setting for discharging the front cover of the discharged booklet to the top, the image processing unit does not perform the image processing for rotating the acquired image if the rotation of the acquired image is determined to not be required, and the image processing unit performs the image processing for rotating the acquired image if the rotation of the acquired image is determined to be required.

6. The image forming apparatus according to claim 5, wherein the image processing unit performs the determination based on the received bookbinding setting, the acquired capability information, and the information indicating the rotational angle of the image denoted by the image data.

7. The image forming apparatus according to claim 5, wherein, in a case where the reception unit does not receive the discharge sheet surface setting, the image processing unit does not perform the image processing for rotating the acquired image.

8. The image forming apparatus according to claim 3, wherein, in a case where the reception unit receives a discharge sheet surface setting for discharging a front cover of the discharged booklet to the bottom, the image processing unit does not perform the image processing for rotating the acquired image if the rotation of the acquired image is determined to not be required, and the image processing unit performs the image processing for rotating the acquired image if the rotation of the acquired image is determined to be required.

9. The image forming apparatus according to claim 1, wherein an N-th image to be rotated includes an image of an N-th page of the acquired image data and an image of an (n+1−N)-th page of the acquired image data, where n denotes the total number of pages of the acquired image data.

10. The image forming apparatus according to claim 1, wherein the image processing unit rotates the image by 180 degrees.

11. The image forming apparatus according to claim 1, wherein the opening direction is a leftward, rightward, upward, or downward opening direction.

12. The image forming apparatus according to claim 1, wherein sheets with the image printed thereon are subjected to saddle stitch bookbinding by the post-processing apparatus, where the booklet is discharged from the post-processing apparatus.

13. The image forming apparatus according to claim 1, wherein the reception unit receives the bookbinding setting via a printer driver.

14. A method for image processing, the method comprising:
receiving a bookbinding setting for setting an opening direction of a booklet discharged after sheets are bound by a post-processing apparatus;
acquiring image data;
performing image processing, based on the received bookbinding setting; for rotating an image based on the image data; and
printing the image subjected to the image processing on a sheet,
wherein printed sheets are conveyed to the post-processing apparatus, bound into a booklet, and the booklet discharged based on the received bookbinding setting.

15. The method according to claim 14, wherein the image processing includes, based on the received bookbinding setting and capability information for the post-processing apparatus rotating the image based on the image data.

16. The method according to claim 15, wherein the bookbinding setting includes a setting whether to discharge a front cover of the booklet to a top or a bottom when the booklet is discharged from the post-processing apparatus.

17. The method according to claim 16,
wherein, acquiring the image data includes acquiring information indicating a rotational angle of the image denoted by the acquired image data, and
wherein, the image processing, based on the received bookbinding setting, the acquired capability information, and the information indicating the rotational angle of the image denoted by the acquired image data, includes rotating the image based on the image data.

18. The method according to claim 16, wherein, in a case where a discharge sheet surface setting for discharging the front cover of the discharged booklet to the top is received, image processing for rotating the acquired image is not performed if the rotation of the acquired image is determined to not be required, and the image processing for rotating the acquired image is performed if the rotation of the acquired image is determined to be required.

19. The method according to claim 18, wherein the image processing performs the determination based on the received bookbinding setting, the acquired capability information, and the information indicating the rotational angle of the image denoted by the image data.

20. The method according to claim 18, wherein, in a case where the discharge sheet surface setting is not received, the image processing does not perform the image processing for rotating the acquired image.

21. The method according to claim 16, wherein, in a case where a discharge sheet surface setting for discharging the front cover of the discharged booklet to the bottom is received, the image processing for rotating the acquired image is not performed if the rotation of the acquired image is determined to not be required, and the image processing is performed for rotating the acquired image if the rotation of the acquired image is determined to be required.

22. The method according to claim 14, wherein an N-th image to be rotated includes an image of an N-th page of the acquired image data and an image of an (n+1−N)-th page of the acquired image data, where n denotes the total number of pages of the acquired image data.

23. The method according to claim 14, wherein, in the image processing, the image is rotated by 180 degrees.

24. The method according to claim 14, wherein the opening direction is a leftward, rightward, upward, or downward opening direction.

25. The method according to claim 14, wherein sheets with the image printed thereon are subjected to saddle stitch bookbinding by the post-processing apparatus, where the booklet is discharged from the post-processing apparatus.

26. The method according to claim 14, wherein the bookbinding setting is received via a printer driver.
